(19) United States
(12) Patent Application Publication
(10) Pub. No.: US 2024/0242877 A1
(43) Pub. Date: Jul. 18, 2024

(54) SINGLE TURN TRANSFORMER WITH MIDDLE POINT CONNECTION

(71) Applicant: Lear Corporation, Southfield, MI (US)

(72) Inventors: Antonio PALOMO LORENZO, Valls (ES); Hector SARNAGO ANDIA, Olvega (Soria) (ES); Oscar LUCIA GIL, Zaragoza (ES); Ruben MOLINA LLORENTE, Valls (ES); Antonio MARTINEZ PEREZ, Valls (ES); Pablo GAONA ROSANES, Valls (ES); Rafael JIMENEZ PINO, Valls (ES)

(73) Assignee: Lear Corporation, Southfield, MI (US)

(21) Appl. No.: 18/498,106

(22) Filed: Oct. 31, 2023

Related U.S. Application Data
(60) Provisional application No. 63/480,172, filed on Jan. 17, 2023.

(51) Int. Cl. H01F 27/28; H01F 27/245

(52) U.S. Cl. CPC H01F 27/2852; H01F 27/245; H01F 27/2823; H01F 2027/065

(57) ABSTRACT

The present disclosure provides a transformer including a first electrical conductor having a plurality of turns, and a second electrical conductor having only a single turn comprising a first leg and a second leg. A first electrical connection for the second electrical conductor is formed at an end of the first leg, a second electrical connection for the second electrical conductor is formed at an end of the second leg, and a middle point electrical connection for the second electrical conductor is formed at a juncture of the first leg and the second leg.

### CROSS-REFERENCE TO RELATED APPLICATION

This application claims the benefit of U.S. Provisional Application Ser. No. 63/480,172 filed on Jan. 17, 2023, the disclosure of which is hereby incorporated by reference herein in its entirety.

### TECHNICAL FIELD

The present disclosure relates to single turn transformer having a middle point connection.

### BRIEF DESCRIPTION OF THE DRAWINGS

FIG. 1 is a simplified electrical schematic/block diagram of a non-limiting, exemplary embodiment of a DC-to-DC converter;

FIG. 2 is an exploded perspective view of a transformer according to one non-limiting exemplary embodiment of the present application;

FIG. 3 is a perspective view of a transformer according to one non-limiting exemplary embodiment of the present application;

FIG. 4 is a side view of a transformer according to one non-limiting exemplary embodiment of the present application; and

FIG. 5 is a side view of a transformer according to one non-limiting exemplary embodiment of the present application.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, features, and elements have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” and/or “at least one” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms.

These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

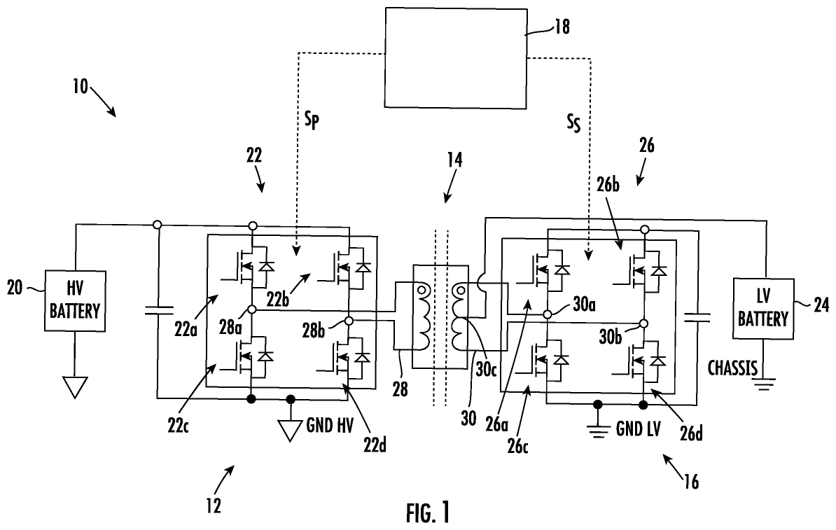

The present disclosure relates to a single turn transformer in a direct-current-to-direct- current (DC-to-DC) voltage converter. In that regard, FIG. 1 is a simplified electrical schematic/block diagram of a non-limiting, exemplary embodiment of a DC-to-DC converter 10, which may be used in an electric vehicle (EV) or a hybrid electric vehicle (HEV).

In the embodiment shown, the converter 10 comprises a primary stage 12, a transformer 14, a secondary stage 16, and a controller 18. In that regard, it is noted that a DC-to-DC converter used in an EV or HEV may have two parallel DC-to-DC converter rails connected at an output. Only one such rail is shown in FIG. 1 for simplicity.

A high-voltage (HV) battery 20 is connected to the primary stage 12, which comprises an H-Bridge configuration 22 of a plurality of metal-oxide semiconductor field-effect transistors (MOSFETs) 22a, 22b, 22c, 22d. A low-voltage (LV) battery 24, which may be part of a vehicle low-voltage network, is connected to the secondary stage 16, which comprises an H-Bridge configuration 26 of a plurality of MOSFETs 26a, 26b, 26c, 26d. The DC-to-DC converter 10 may thus be referred to as having a dual active bridge topology. It is noted that the primary stage 12 may alternatively be referred to as a first or high-voltage stage or side, and that the secondary stage 16 may alternatively be referred to as a second or low-voltage stage or side.

As is well known to those of ordinary skill, the controller 18 is configured to control and controls the ON/OFF switching operations, including duty cycle, of the transistors of the H-Bridge 22 and the transistors of the H-Bridge 26 via switching control signals (s) generated by and transmitted from the controller 18 to the MOSFETs 22a, 22b, 22c, 22d of the primary stage 12 and switching control signals (s) generated by and transmitted from the controller 18 to the MOSFETs 26a, 26b, 26c, 26d of the secondary stage 16 according to a desired switching frequency. In such a fashion, the controller 18 operates the DC-to-DC converter 10 in a mode in order to convert the high-voltage supplied by the HV battery 20 to a low-voltage and thereby charge the LV battery 24 and/or power the vehicle low voltage network. In that regard, it is also noted that the DC-to-DC converter 10 maybe bi-directional, also passing energy from LV to HV. As used herein, high- voltage (HV) may refer to a voltage greater than or equal 48 volts, while low-voltage (LV) may refer to a voltage less than or equal to 24 volts.

The transformer 14 comprises a first or high-voltage or primary coil 28 and a second or low-voltage or secondary coil 30. The primary coil 28 includes a first connection 28a and a second connection 28b that connect the primary coil 28 to the MOSFETS 22a, 22b, 22c, 22d of the H- Bridge 22 as shown. The secondary coil 30 includes a first connection 30aand a second connection 30bthat connect the secondary coil 30 to the MOSFETS 26a, 26b, 26c, 26d of the H-Bridge 26 as shown. The secondary coil 30 also includes a middle point connection 30c that connects a middle point of the secondary coil 30 to the LV battery 24. Such a DC-to-DC converter is shown and described in detail in U.S. Pat. No. 11,502,613 B2, which is hereby incorporated herein by reference in its entirety and attached hereto as Appendix A.

As those skilled in the art will understand, the controller 18, as well as any other component, system, subsystem, unit, module, circuit, stage, interface, sensor, device, or the like described herein may individually, collectively, or in any combination comprise appropriate circuitry, such as one or more appropriately programmed processors (e.g., one or more microprocessors including central processing units (CPU)) and associated memory, which may include stored operating system software, firmware, and/or application software executable by the processor(s) for controlling operation thereof, any component, system, subsystem, unit, module, circuit, stage, interface, sensor, device, or the like described herein, and/or for performing the particular algorithm or algorithms represented by the various methods, functions and/or operations described herein, including interaction between and/or cooperation with each other.

Such a HV to LV DC-to-DC converter 10 transfers energy (power) from a high-voltage and a low-current to a low-voltage and a high-current. In that regard, considering a 4 kilowatt (kW) DC-to-DC converter, converting from 400 Volts to 12 Volts, then the current at the primary may be 10 Amperes (A) and the current at the secondary may be 333A (i.e., P=IV). It is noted that these are exemplary, theoretical current values, without considering efficiency losses. In actual cases, the primary or input current may be higher, for example up to 20A, while the secondary or output current may be lower. As used herein, then, low-current may refer to a current less than or equal to 20A, while high-current may refer to a current greater than or equal to 150A, although other low-current and high-current thresholds may be applicable depending on the specific power of the DC-to-DC converter and the specific high and low voltages involved in the DC-to-DC conversion. The transformer 14 of such a DC-to-DC converter 10 maybe fully made (i.e., both the primary coil and the secondary coil) of well-known Litz wire conductors, which adds additional losses.

Alternatively, such a transformer 14 maybe made as a hybrid comprising a Litz wire primary coil conductor and a secondary coil that comprises multiple conductors embedded in layers of a printed circuit board. In that regard, the multiple conductors of the secondary may be connected in parallel, and each may be configured as a single turn. Such a hybrid transformer for a DC-to-DC converter provides for volume and cost optimization and is shown and described in detail in U.S. patent Application Publication No. 2020/0258675 A1, which is hereby incorporated herein by reference in its entirety and attached hereto as Appendix B.

Such a hybrid transformer, however, does not include a middle point connection as shown in FIG. 1. In that regard, because the secondary coil is embedded in a printed circuit board, a single point connection cannot be made without increasing either the size (area) or the number of layers of the printed circuit board, thereby sacrificing the volume and cost optimization noted. Moreover, while the transformer 14 shown in FIG. 1 includes a middle point connection implemented in a multiple turn secondary coil, such an implementation is complex and requires a specially adapted connection that provides for appropriate isolation. Furthermore, a multiple turn secondary coil such as that shown in the transformer of FIG. 1 cannot be implemented in a coiled rigid bar with a rectangular cross-section and coated for isolation.

The present disclosure addresses such problems by providing a compact and efficient solution of a transformer having a LV-side with a middle point connection and capable of handling a high amount of current. In that regard, according to the present disclosure, a transformer for HV to LV conversion is provided where the LV-side is a single-turn (i.e., 1-turn) coil with a middle point connection, and that is made from an electrical conductor in the form of a thick busbar plate to handle a high-current.

More specifically, the present disclosure provides a transformer in which the HV-side may comprise a Litz-wire multi-turn coil that may be supported on a plastic reel, and in which the LV- side comprises a single-turn coil made from an electrically conductive thick busbar plate and having a middle point connection. The present disclosure thus enables an easy layout and simplifies a middle point connection, while maintaining optimized cost and volume. Also, multiple soldering points of the busbar to a printed circuit board enable not only electrical connection of the transformer but also mechanical fixation that facilitates connection to a heat dissipator and/or use in an automotive product without the need for fixation clips.

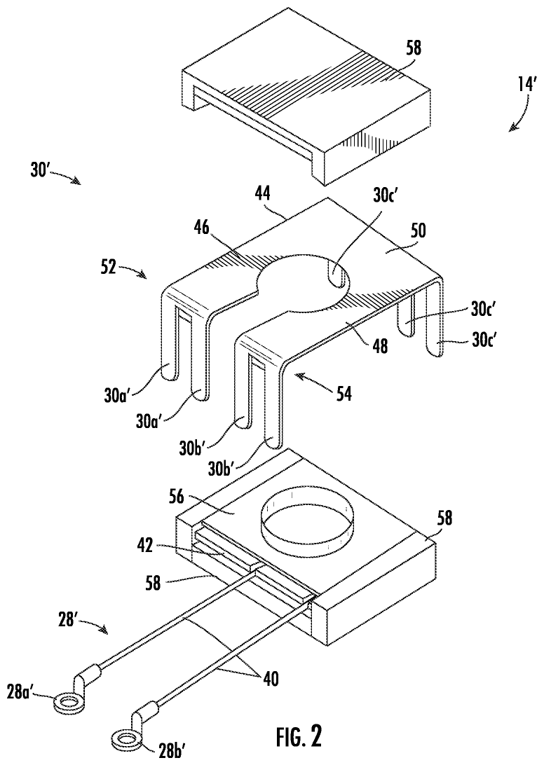

FIG. 2 is an exploded perspective view of a transformer 14′ according to one non-limiting exemplary embodiment of the present application. As seen therein, the transformer 14′ comprises a first electrical conductor 40 having a plurality of turns (not shown). In that regard, the first electrical conductor 40 may comprise a Litz wire and may be wound or coiled on and/or supported by a plastic reel 42, and may be referred to as a first or high-voltage or primary coil 28′.

The transformer 14′ also comprises a second electrical conductor 44 having only a single turn comprising a first leg 46 and a second leg 48, which are joined at a juncture 50. In that regard, the second electrical conductor 44 may comprise a copper or other electrical conductor in the form of a thick busbar plate, e.g., having a thickness in the range of 0.5 millimeters (mm) to 3 mm depending on its shape and connections as well as current flow requirements, and may be referred to as a second or low-voltage or secondary coil 30′.

At least one first electrical connection 30a′ for the second electrical conductor 44 is formed at an end 52 of the first leg 46. At least one second electrical connection 30b′ for the second electrical conductor 44 is formed at an end 54 of the second leg 48. At least one middle point electrical connection 30c′ for the second electrical conductor 44 is formed at the juncture 50 of the first leg 46 and the second leg 48. As seen in FIG. 2, the at least one first electrical connection 30a′ is formed as at least one member extending at an angle (e.g.,) 90° from the end 52 of the first leg 46 of the second electrical conductor 44, such as may be formed by bending of an extension from the busbar plate. Similarly, the at least one second electrical connection 30b′ is formed as at least one member extending at an angle (e.g., 90°) from the end 54 of the second leg 48 of the second electrical conductor 44. The at least one middle point electrical connection 30c′ is also formed as at least one member extending at an angle (e.g., 90°)from the juncture 50 of the first leg 46 and the second leg 48.

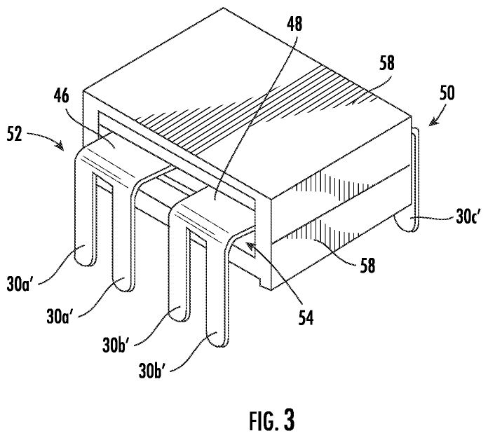

Still referring to FIG. 2, a ferromagnetic core 56, which may be formed as a plate, is interposed between the first and second electrical conductors 40, 44. A ferromagnetic material 58 also surrounds the first and second electrical conductors 40, 44. FIG. 3 is an assembled perspective view of the transformer 14′ shown in exploded view in FIG. 2.

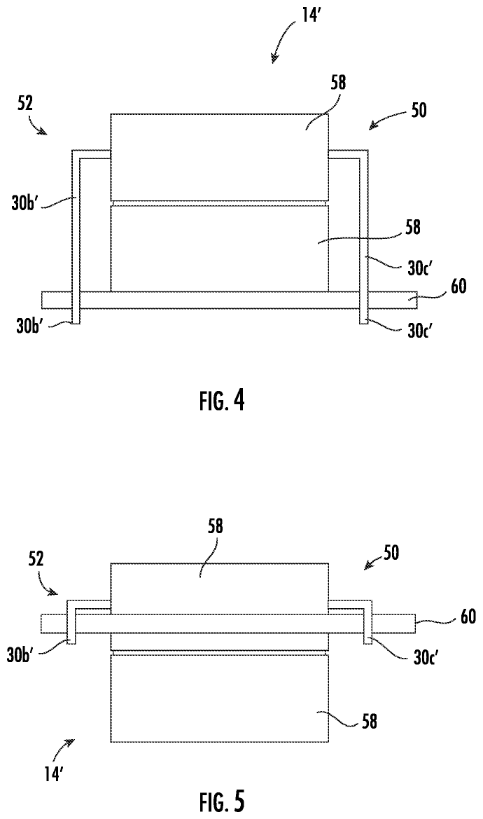

FIGS. 4 and 5 are side views of transformers 14′ according to non-limiting exemplary embodiments of the present application. As seen therein, FIG. 4 illustrates the transformer 14′ over or on a printed circuit board 60, while FIG. 5 illustrates the transformer 14′ crossing through a printed circuit board 60. As also seen therein, the at least one first electrical connection 30a′ (not shown), the at least one second electrical connection 30b′, and the at least one middle point connection 30c′ extending from the second conductor 44 (see FIG. 2) are all electrically connected (e.g., soldered) to the printed circuit board 60 to thereby provide electrical connections for the transformer 14′, such as in a DC-to-DC converter 10 (see FIG. 1). Moreover, once connected to the printed circuit board 60, the at least one first electrical connection 30a′ (not shown), the at least one second electrical connection 30b′, and the at least one middle point connection 30c′ extending from the second conductor 44 (see FIG. 2) also provide mechanical fixation of the transformer 14′ to or in the printed circuit board 60.

The present disclosure thus provides an inexpensive and compact transformer having a middle point connection. The busbar secondary with multiple soldering points to a printed circuit board also enable not only electrical connection of the transformer but also mechanical fixation that facilitates connection to a heat dissipator and/or use in an automotive product without the need for fixation clips.

Item 1: According to an embodiment, the present disclosure provides a transformer comprising a first electrical conductor having a plurality of turns, and a second electrical conductor having only a single turn comprising a first leg and a second leg, wherein a first electrical connection for the second electrical conductor is formed at an end of the first leg, a second electrical connection for the second electrical conductor is formed at an end of the second leg, and a middle point electrical connection for the second electrical conductor is formed at a juncture of the first leg and the second leg.

Item 2: In another embodiment, the present disclosure provides the transformer according to Item 1 wherein the second electrical conductor comprises a plate.

Item 3: In another embodiment, the present disclosure provides the transformer according to Item 1 or Item 2 further comprising a ferromagnetic core interposed between the first electrical conductor and the second electrical conductor.

Item 4: In another embodiment, the present disclosure provides the transformer according to any of Items 1-3 wherein the ferromagnetic core comprises a plate.

Item 5: In another embodiment, the present disclosure provides the transformer according to any of Items 1-4 further comprising a ferromagnetic material surrounding the first electrical conductor and the second electrical conductor.

Item 6: In another embodiment, the present disclosure provides the transformer according to any of Items 1-5 wherein the first electrical conductor comprises a wire.

Item 7: In another embodiment, the present disclosure provides the transformer according to any of Items 1-6 further comprising a plastic reel for supporting the wire.

Item 8: In another embodiment, the present disclosure provides the transformer according to any of Items 1-7 wherein the first electrical connection comprises at least one member extending from the end of the first leg.

Item 9: In another embodiment, the present disclosure provides the transformer according to any of Items 1-8 wherein the first electrical connection provides electrical connection and mechanical fixation of the transformer to a printed circuit board.

Item 10: In another embodiment, the present disclosure provides the transformer according to any of Items 1-9 wherein the second electrical connection comprises at least one member extending from the end of the second leg.

Item 11: In another embodiment, the present disclosure provides the transformer according to any of Items 1-10 wherein the second electrical connection provides electrical connection and mechanical fixation of the transformer to a printed circuit board.

Item 12: In another embodiment, the present disclosure provides the transformer according to any of Items 1-11 wherein the middle point electrical connection comprises at least one member extending from the juncture of the first leg and the second leg.

Item 13: In another embodiment, the present disclosure provides the transformer according to any of Items 1-12 wherein the middle point electrical connection provides electrical connection and mechanical fixation of the transformer to a printed circuit board.

Item 14: In another embodiment, the present disclosure provides the transformer according to any of Items 1-13 wherein the first coil receives a voltage of greater than or equal to 48 volts and the second coil produces a voltage of less than or equal to 24 volts.

Item 15: Item 2: In another embodiment, the present disclosure provides a DC-to-DC converter comprising the transformer according to any of Items 1-14.

Item 16: According to an embodiment, the present disclosure provides a transformer comprising a first electrical conductor having a plurality of turns, a second electrical conductor having only a single turn comprising a first leg and a second leg, a first electrical connection for the second electrical conductor comprising at least one member extending from the first leg to provide electrical connection and mechanical fixation of the transformer to a printed circuit board, a second electrical connection for the second electrical conductor comprising at least one member extending from the end of the second leg to provide electrical connection and mechanical fixation of the transformer to the printed circuit board, and a middle point electrical connection for the second electrical conductor comprising at least one member extending from a juncture of the first leg and the second leg to provide electrical connection and mechanical fixation of the transformer to the printed circuit board.

Item 17: In another embodiment, the present disclosure provides the transformer according to Item 16 wherein the second electrical conductor comprises a plate.

Item 18: In another embodiment, the present disclosure provides the transformer according to Item 16 or Item 17 further comprising a ferromagnetic plate interposed between the first electrical conductor and the second electrical conductor.

Item 19: In another embodiment, the present disclosure provides the transformer according to any of Items 16-18 wherein the first coil receives a voltage of greater than or equal to 48 volts and the second coil produces a voltage of less than or equal to 24 volts.

Item 20: In another embodiment, the present disclosure provides a DC-to-DC converter comprising the transformer according to any of Items 16-19.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure.

Additionally, unless the context clearly indicates otherwise, the various features, elements, components, methods, procedures, steps, and/or functions of various implementing embodiments may be combined or utilized in any combination or combinations and/or may be performed in any order other than those specifically described herein to form further embodiments according to the present disclosure.

What is claimed is:

1. A transformer comprising:
a first electrical conductor having a plurality of turns; and
a second electrical conductor having only a single turn comprising a first leg and a second leg, wherein a first electrical connection for the second electrical conductor is formed at an end of the first leg, a second electrical connection for the second electrical conductor is formed at an end of the second leg, and a middle point electrical connection for the second electrical conductor is formed at a juncture of the first leg and the second leg.

2. The transformer according to claim 1 wherein the second electrical conductor comprises a plate.

3. The transformer according to claim 1 further comprising a ferromagnetic core interposed between the first electrical conductor and the second electrical conductor.

4. The transformer according to claim 3 wherein the ferromagnetic core comprises a plate.

5. The transformer according to claim 1 further comprising a ferromagnetic material surrounding the first electrical conductor and the second electrical conductor.

6. The transformer according to claim 1 wherein the first electrical conductor comprises a wire.

7. The transformer according to claim 6 further comprising a plastic reel for supporting the wire.

8. The transformer according to claim 1 wherein the first electrical connection comprises at least one member extending from the end of the first leg.

9. The transformer according to claim 1 wherein the first electrical connection provides electrical connection and mechanical fixation of the transformer to a printed circuit board.

10. The transformer according to claim 1 wherein the second electrical connection comprises at least one member extending from the end of the second leg.

11. The transformer according to claim 1 wherein the second electrical connection provides electrical connection and mechanical fixation of the transformer to a printed circuit board.

12. The transformer according to claim 1 wherein the middle point electrical connection comprises at least one member extending from the juncture of the first leg and the second leg.

13. The transformer according to claim 1 wherein the middle point electrical connection provides electrical connection and mechanical fixation of the transformer to a printed circuit board.

14. The transformer according to claim 1 wherein the first coil receives a voltage of greater than or equal to 48 volts and the second coil produces a voltage of less than or equal to 24 volts.

15. A DC-to-DC converter comprising the transformer according to claim 1.

16. A transformer comprising:
a first electrical conductor having a plurality of turns;
a second electrical conductor having only a single turn comprising a first leg and a second leg;
a first electrical connection for the second electrical conductor comprising at least one member extending from the first leg to provide electrical connection and mechanical fixation of the transformer to a printed circuit board;
a second electrical connection for the second electrical conductor comprising at least one member extending from the end of the second leg to provide electrical connection and mechanical fixation of the transformer to the printed circuit board; and
a middle point electrical connection for the second electrical conductor comprising at least one member extending from a juncture of the first leg and the second leg to provide electrical connection and mechanical fixation of the transformer to the printed circuit board.

17. The transformer according to claim 16 wherein the second electrical conductor comprises a plate.

18. The transformer according to claim 16 further comprising a ferromagnetic plate interposed between the first electrical conductor and the second electrical conductor.

19. The transformer according to claim 16 wherein the first coil receives a voltage of greater than or equal to 48 volts and the second coil produces a voltage of less than or equal to 24 volts.

20. A DC-to-DC converter comprising the transformer according to claim 16.
